(19) United States
(12) Patent Application Publication
(10) Pub. No.: US 2026/0160395 A1
(43) Pub. Date: Jun. 11, 2026

(54) LIGHT-EMITTING DIODE TUBE LIGHT HAVING A FLEXIBLE CIRCUIT BOARD CONNECTION STRUCTURE

(71) Applicant: Xiamen PVTECH Co., Ltd., Xiamen (CN)

(72) Inventors: Huibao Luo, Xiamen (CN); FUXING LU, Xiamen (CN)

(73) Assignee: Xiamen PVTECH Co., Ltd., Xiamen (CN)

(21) Appl. No.: 18/974,838

(22) Filed: Dec. 10, 2024

(51) Int. Cl. F21K 9/278; F21Y 103/10; F21Y 115/10

(52) U.S. Cl. CPC F21K 9/278; F21K 9/272; F21Y 2103/10; F21Y 2115/10

(57) ABSTRACT

A light-emitting diode (LED) tube light having a flexible circuit board connection structure includes a light source board, a power board and a flexible circuit board. The flexible circuit board has a first end and a second end. The first end is electrically connected to the light source board. The second end has a welding portion, and the second end is electrically connected to the power board via the welding portion. The flexible circuit board includes a plurality of connection portions and the connection portions are curved in shape, whereby the flexible circuit board is wavy. The above structure can significantly reduce the manufacturing cost of the LED tube light and increase the production efficiency of the LED tube light.

### BACKGROUND OF THE INVENTION

### 1. Field of the Invention

The present invention relates to a light-emitting diode (LED) tube light, in particular to an LED tube light having a flexible circuit board connection structure.

### 2. Description of the Prior Art

The light-emitting diode (LED) tube light has advantages such as energy saving, power efficiency, and high performance, and therefore has been widely applied in various buildings. However, in currently available LED tube lights, the power board and the light source board are generally connected through silicone wires, which leads to higher manufacturing costs and lower production efficiency. Additionally, due to the limited internal space within the end caps, the silicone wires are prone to breakage caused by insufficient space, leading to abnormal power supply or the wires being exposed outside the tube light.

### SUMMARY OF THE INVENTION

One embodiment of the present invention provides a light-emitting diode (LED) tube light having a flexible circuit board connection structure, which includes a light source board, a power board and a flexible circuit board. The flexible circuit board has a first end and a second end. The first end is electrically connected to the light source board. The second end has a welding portion, and the second end is electrically connected to the power board via the welding portion. The flexible circuit board includes a plurality of connection portions and the connection portions are curved in shape, such that the flexible circuit board is wavy.

In one embodiment, the power board has a groove and a plurality of electrodes. The second end passes through the groove and is electrically connected to the electrodes via the welding portion.

In one embodiment, the welding portion includes a plurality of hollow welding pads corresponding to the electrodes respectively. Each of the electrodes has an electrical connection post, and the electrical connection post of each of the electrodes passes through and welded on the hollow welding pad corresponding thereto.

In one embodiment, one end of the groove has an opening and the other end of the groove is sealed.

In one embodiment, both ends of the groove are sealed.

In one embodiment, the electrodes are adjacent to the groove.

In one embodiment, the flexible circuit board is S-shaped.

In one embodiment, the flexible circuit board has a connection circuit and the light source board is electrically connected to the power board via the connection circuit.

In one embodiment, the connection portions include a first connection portion adjacent to the light source board and a second connection adjacent to the power board. The curvature of the first connection portion is greater than the curvature of the second connection portion.

In one embodiment, the LED tube light further includes two end caps and a light cover. The two end caps are disposed at two ends of the light cover, and electrically connected to the power board and the light source board respectively. The power board is disposed in one of the end caps and the light source board is disposed in the light cover.

Another embodiment of the present invention provides a light-emitting diode tube light having a flexible circuit board connection structure, which includes a light source board, a power board and a flexible circuit board. The power board has a groove and a plurality of electrodes. The flexible circuit board has a first end and a second end. The first end is electrically connected to the light source board, and the second end has a welding portion. The second end passes through the groove and is electrically connected to the electrodes via the welding portion.

In one embodiment, the flexible circuit board includes a plurality of connection portions and the connection portions are curved in shape, such that the flexible circuit board is wavy.

In one embodiment, the flexible circuit board is S-shaped.

In one embodiment, the connection portions include a first connection portion adjacent to the light source board and a second connection adjacent to the power board. The curvature of the first connection portion is greater than the curvature of the second connection portion.

In one embodiment, the welding portion includes a plurality of hollow welding pads corresponding to the electrodes respectively. Each of the electrodes has an electrical connection post, and the electrical connection post of each of the electrodes passes through and welded on the hollow welding pad corresponding thereto.

In one embodiment, one end of the groove has an opening and another end of the groove is sealed.

In one embodiment, both ends of the groove are sealed.

In one embodiment, the electrodes are adjacent to the groove.

In one embodiment, the flexible circuit board has a connection circuit and the light source board is electrically connected to the power board via the connection circuit.

In one embodiment, the LED tube light further includes two end caps and a light cover. The two end caps are disposed at two ends of the light cover, and electrically connected to the power board and the light source board respectively. The power board is disposed in one of the end caps and the light source board is disposed in the light cover.

The light-emitting diode tube light having the flexible circuit board connection structure in accordance with the embodiments of the present invention may have the following advantages:
(1) In one embodiment of the present invention, the LED tube light includes a light source board, a power board and a flexible circuit board. The flexible circuit board has a first end and a second end. The first end is electrically connected to the light source board. The second end has a welding portion, and the second end is electrically connected to the power board via the welding portion. The flexible circuit board includes a plurality of connection portions and the connection portions are curved in shape, whereby the flexible circuit board is wavy. The above structure can significantly reduce the manufacturing cost of the LED tube light and increase the production efficiency of the LED tube light.
(2) In one embodiment of the present invention, the LED tube light has the flexible circuit board connection structure, so the power board of the LED tube light can be electrically connected to the light source board via the flexible circuit board having the connection circuit. Thus, the flexible circuit board connection structure will not be influenced by the limited space of the end caps, such that the power board and the light source board can normally operate.
(3) In one embodiment of the present invention, the LED tube light has the flexible circuit board connection structure, and the flexible circuit board is S-shaped and has a first connection portion and a second connection portion. The curvature of the first connection portion adjacent to the light source board is greater than that of the second connection portion adjacent to the power board. The above structure can optimize the stress distribution of the flexible circuit board without influencing the signal transmission function of the flexible circuit board.
(4) In one embodiment of the present invention, the power board of the LED tube light has a groove and a plurality of electrodes. The second end of the flexible circuit board passes through the groove and is electrically connected to the electrodes via the welding portion. The above special-designed groove structure can provide an effective position-limiting effect, such that the flexible circuit board can be stably fixed with the power board. Besides, the above special-designed groove structure can effectively reduce the stress applied to the flexible circuit board during the installation process so as to avoid that the welding points are damaged accordingly. In addition, the above special-designed groove structure can effectively prevent defective welding conditions. In this way, the quality and reliability of the LED tube light can be greatly enhanced.
(5) In one embodiment of the present invention, the flexible circuit board of the LED tube light has the welding portion and the welding portion includes a plurality of hollow welding pads corresponding to the electrodes respectively. Each electrode has an electrical connection post and the electrical connection post of each electrode passes through and welded on the hollow welding pad corresponding thereto. Via the structure design of the hollow welding pads and electrical connection posts, the welding process can be finished by automated welding technique in a short time. Further, the above structure design can also effectively decrease the stress applied to the flexible circuit board in order to avoid that the welding points are damaged. In this way, the quality and reliability of the LED tube light can be further improved.
(6) In one embodiment of the present invention, the LED tube light has the flexible board connection structure, enabling the power board of the LED tube light to be electrically connected to the light source board via the flexible board having the connection circuit. Additionally, the flexible board will not break due to insufficient space, thereby effectively enhancing the service life of the LED tube light.
(7) In one embodiment of the present invention, the flexible board connection structure can be applied not only to tube lights but also to various other types of lighting devices, making it more versatile in applications and providing greater flexibility in use.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the exploded view of the LED tube light having the flexible circuit board connection structure in accordance with the first embodiment of the present invention.

FIG. 2 is the partial enlargement view of the LED tube light having the flexible circuit board connection structure in accordance with the first embodiment of the present invention.

FIG. 3 is the partial enlargement view of the LED tube light having the flexible circuit board connection structure in accordance with the second embodiment of the present invention.

FIG. 4 is the partial enlargement view the power board of the LED tube light having the flexible circuit board connection structure in accordance with the second embodiment of the present invention.

FIG. 5 is the partial enlargement view of the flexible circuit board of the LED tube light having the flexible circuit board connection structure in accordance with the second embodiment of the present invention.

FIG. 6 is the schematic view of the connection structure of the flexible circuit board and the power board of the LED tube light having the flexible circuit board connection structure in accordance with the second embodiment of the present invention.

FIG. 7 is the schematic view of the connection structure of the flexible circuit board and the power board of the LED tube light having the flexible circuit board connection structure in accordance with the third embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

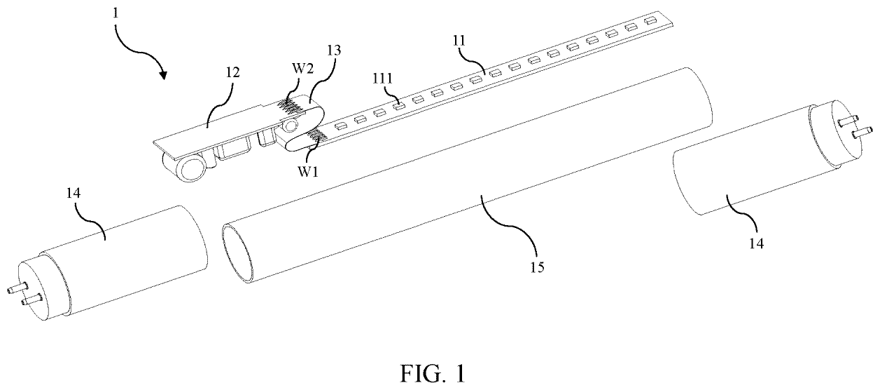

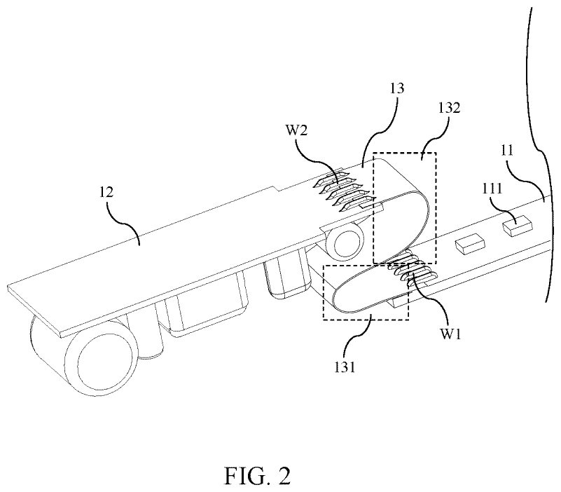

Please refer to FIG. 1 and FIG. 2. FIG. 1 is the exploded view of the LED tube light having the flexible circuit board connection structure in accordance with the first embodiment of the present invention. FIG. 2 is the partial enlargement view of the LED tube light having the flexible circuit board connection structure in accordance with the first embodiment of the present invention. As shown in FIG. 1 and FIG. 2, the light-emitting diode (LED) tube light 1 includes a light source board 11, a power board 12, a flexible circuit board 13, two end caps 14, and a light cover 15.

The light source board 11 has a plurality of light sources 111. In one embodiment, these light sources 111 can be LEDs. In another embodiment, these light sources 111 can also be other currently available light-emitting elements.

The power board 12 includes a power circuit, a driver circuit, and other related circuits. The power board 12 is used to drive the light source board 11 to emit light.

The flexible circuit board 13 has a first end and a second end. The first end of the flexible circuit board 13 is electrically connected to the light source board 11 via a welding portion W1, and the second end of the flexible circuit board 13 is electrically connected to the power board 12 through a welding portion W2. The flexible circuit board 13 has a connection circuit, enabling the light source board 11 to be electrically connected to the power board 12 through the connection circuit. The flexible circuit board 13 includes a plurality of curved connection portions, making the flexible circuit board 13 wavy. In one embodiment, the flexible circuit board 13 may be a Flexible Printed Circuit (FPC) or other similar components.

The two end caps 14 are respectively located at both ends of the light cover 15 and are electrically connected to the power board 12 and the light source board 11. The power board 12 is installed inside one of the end caps 14, while the light source board 11 is installed inside the light cover 15.

As shown in FIG. 2, the flexible circuit board 13 is S-shaped and includes a first connection portion 131 and a second connection portion 132. The first connection portion 131 is adjacent to the light source board 11, and the second connection portion 132 is adjacent to the power board 12. The curvature of the first connection portion 131 is greater than that of the second connection portion 132.

The flexible circuit board 13 is S-shaped, with the first connection portion 131 and second connection portion 132. The curvature of the first connection portion 131, which is adjacent to the light source board 11, is greater than the curvature of the second connection portion 132, which is adjacent to the power board 12. This structure optimizes the stress distribution of the flexible circuit board 13 and does not affect the signal transmission function thereof, allowing both the light source board 11 and the power board 12 to function properly.

Moreover, as mentioned earlier, the flexible circuit board 13 contains a connection circuit that integrates all necessary circuits together, significantly reducing its size and minimizing the risk of breakage. As a result, the failure rate of the LED tube light 1 is reduced, effectively increasing its service life.

The flexible circuit board connection structure can be applied not only to tube lights but also to various other types of lighting devices, making it more versatile in application and more flexible in use.

As described above, the LED tube light 1 includes the light source board 11, the power board 12, and the flexible circuit board 13. The flexible circuit board 13 has the first end electrically connected to the light source board 11 and the second end with the welding portion W2, which is electrically connected to the power board 12. The flexible circuit board 13 includes several curved connection portions, such that the flexible circuit board is wavy. This structure significantly reduces the manufacturing cost of the LED tube light 1 and improves the production efficiency thereof.

After the welding process is completed, a series of environmental adaptability tests (such as temperature and humidity changes) are conducted on the LED tube light 1 with the flexible board 13. The performance of the LED tube light 1 remains stable throughout, ensuring that the LED tube light 1 can function properly under various conditions.

The embodiment just exemplifies the present invention and is not intended to limit the scope of the present invention; any equivalent modification and variation according to the spirit of the present invention is to be also included within the scope of the following claims and their equivalents.

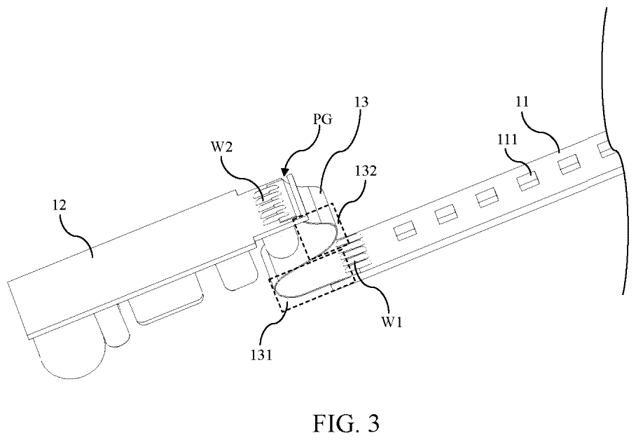

Please refer to FIG. 3, which is the partial enlargement view of the LED tube light having the flexible circuit board connection structure in accordance with the second embodiment of the present invention. As shown in FIG. 3, the difference between this embodiment and the previous embodiment is that the power board 12 has a groove PG. The second end of the flexible circuit board 13 passes through the groove PG, and is electrically connected to the power board 12 via the welding portion W2. One end of the groove PG has an opening and the other end of the groove PG is sealed.

The above special-designed groove structure can provide an effective position-limiting effect, such that the flexible circuit board 13 can be stably fixed with the power board 12. Besides, the above special-designed groove structure can effectively reduce the stress applied to the flexible circuit board 13 during the installation process so as to avoid that the welding points are damaged accordingly. In addition, the above special-designed groove structure can effectively prevent from defective welding conditions. In this way, the quality and reliability of the LED tube light 1 can be greatly enhanced.

The embodiment just exemplifies the present invention and is not intended to limit the scope of the present invention; any equivalent modification and variation according to the spirit of the present invention is to be also included within the scope of the following claims and their equivalents.

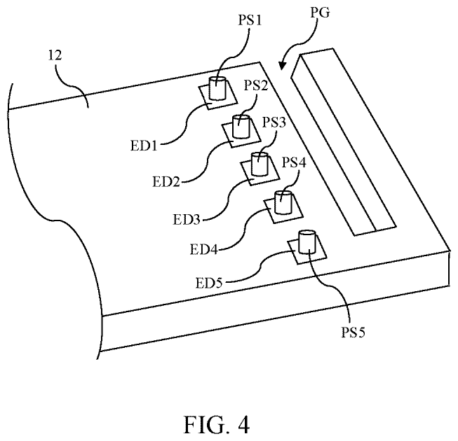

Please refer to FIG. 4, which is the partial enlargement view the power board of the LED tube light having the flexible circuit board connection structure in accordance with the second embodiment of the present invention. Please also refer to FIG. 3. As shown in FIG. 3 and FIG. 4, the power board 12 has a groove PG and five electrodes ED1, ED2, ED3, ED4, ED5. The second end of the flexible circuit board 13 passes through the groove PG, and is electrically connected to the electrodes ED1, ED2, ED3, ED4, ED5 via the welding portion W2. The electrode ED1 has an electrical connection port PS1. The electrode ED2 has an electrical connection port PS2. The electrode ED3 has an electrical connection port PS3. The electrode ED4 has an electrical connection port PS4. The electrode ED5 has an electrical connection port PS5. The structure of the welding portion W1 may be the same with that of the welding portion W2.

The embodiment just exemplifies the present invention and is not intended to limit the scope of the present invention; any equivalent modification and variation according to the spirit of the present invention is to be also included within the scope of the following claims and their equivalents.

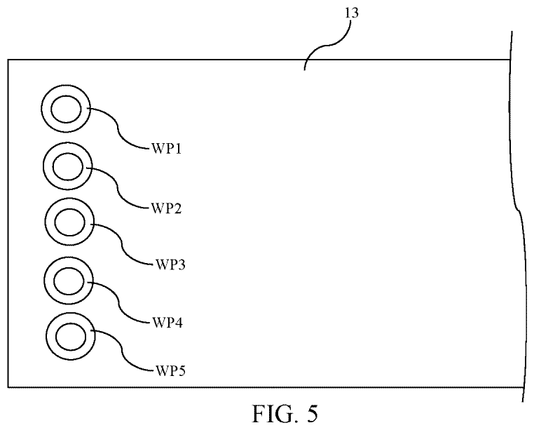

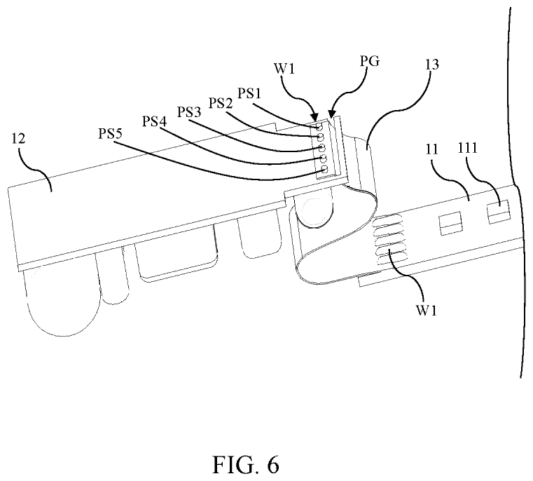

Please refer to FIG. 5 and FIG. 6. FIG. 5 is the partial enlargement view of the flexible circuit board of the LED tube light having the flexible circuit board connection structure in accordance with the second embodiment of the present invention. FIG. 6 is the schematic view of the connection structure of the flexible circuit board and the power board of the LED tube light having the flexible circuit board connection structure in accordance with the second embodiment of the present invention. As shown in FIG. 5, the welding portion W2 of the second end of the flexible circuit board 13 includes a plurality of hollow welding pads WP1, WP1, WP3, WP4, WP5 corresponding to the electrodes ED1, ED2, ED3, ED4, ED5 respectively.

As shown in FIG. 6, the electrical connection post PS1 of the electrode ED1 passes the hollow welding pad WP1 corresponding thereto. The electrical connection post PS2 of the electrode ED2 passes the hollow welding pad WP2 corresponding thereto. The electrical connection post PS3 of the electrode ED3 passes the hollow welding pad WP3 corresponding thereto. The electrical connection post PS4 of the electrode ED4 passes the hollow welding pad WP4 corresponding thereto. The electrical connection post PS5 of the electrode ED5 passes the hollow welding pad WP5 corresponding thereto. The welding portion W1 can be also electrically connected to the light source board 11 via the same structure.

Via the structure design of the hollow welding pads WP1, WP1, WP3, WP4, WP5 and electrical connection posts PS1, PS2, PS3, PS4, PS5, the welding process can be finished by automated welding technique in a short time. Further, the above structure design can also effectively decrease the stress applied to the flexible circuit board 13 in order to avoid that the welding points are damaged. In this way, the quality and reliability of the LED tube light 1 can be further improved.

The embodiment just exemplifies the present invention and is not intended to limit the scope of the present invention; any equivalent modification and variation according to the spirit of the present invention is to be also included within the scope of the following claims and their equivalents.

It is worthy to point out that in currently available LED tube lights, the power board and the light source board are generally connected through silicone wires, which leads to higher manufacturing costs and lower production efficiency. Additionally, due to the limited internal space within the end caps, the silicone wires are prone to breakage caused by insufficient space, leading to abnormal power supply or the wires being exposed outside the tube light. By contrast, according to one embodiment of the present invention, the LED tube light includes a light source board, a power board and a flexible circuit board. The flexible circuit board has a first end and a second end. The first end is electrically connected to the light source board. The second end has a welding portion, and the second end is electrically connected to the power board via the welding portion. The flexible circuit board includes a plurality of connection portions and the connection portions are curved in shape, whereby the flexible circuit board is wavy. The above structure can significantly reduce the manufacturing cost of the LED tube light and increase the production efficiency of the LED tube light.

According to one embodiment of the present invention, the LED tube light has the flexible circuit board connection structure, so the power board of the LED tube light can be electrically connected to the light source board via the flexible circuit board having the connection circuit. Thus, the flexible circuit board connection structure will not be influenced by the limited space of the end caps, such that the power board and the light source board can normally operate.

According to one embodiment of the present invention, the LED tube light has the flexible circuit board connection structure, and the flexible circuit board is S-shaped and has a first connection portion and a second connection portion. The curvature of the first connection portion adjacent to the light source board is greater than that of the second connection portion adjacent to the power board. The above structure can optimize the stress distribution of the flexible circuit board without influencing the signal transmission function of the flexible circuit board.

Also, according to one embodiment of the present invention, the power board of the LED tube light has a groove and a plurality of electrodes. The second end of the flexible circuit board passes through the groove and is electrically connected to the electrodes via the welding portion. The above special-designed groove structure can provide an effective position-limiting effect, such that the flexible circuit board can be stably fixed with the power board. Besides, the above special-designed groove structure can effectively reduce the stress applied to the flexible circuit board during the installation process so as to avoid that the welding points are damaged accordingly. In addition, the above special-designed groove structure can effectively prevent from defective welding conditions. In this way, the quality and reliability of the LED tube light can be greatly enhanced.

Further, according to one embodiment of the present invention, the flexible circuit board of the LED tube light has the welding portion and the welding portion includes a plurality of hollow welding pads corresponding to the electrodes respectively. Each electrode has an electrical connection post and the electrical connection post of each electrode passes through and welded on the hollow welding pad corresponding thereto. Via the structure design of the hollow welding pads and electrical connection posts, the welding process can be finished by automated welding technique in a short time. Further, the above structure design can also effectively decrease the stress applied to the flexible circuit board in order to avoid that the welding points are damaged. In this way, the quality and reliability of the LED tube light can be further improved.

Moreover, according to one embodiment of the present invention, the LED tube light has the flexible board connection structure, enabling the power board of the LED tube light to be electrically connected to the light source board via the flexible board having the connection circuit. Additionally, the flexible board will not break due to insufficient space, thereby effectively enhancing the service life of the LED tube light.

Furthermore, according to one embodiment of the present invention, the flexible board connection structure can be applied not only to tube lights but also to various other types of lighting devices, making it more versatile in applications and providing greater flexibility in use. As set forth above, the LED tube light having the flexible circuit board connection structure according to the embodiments of the present invention can definitely achieve great technical effects.

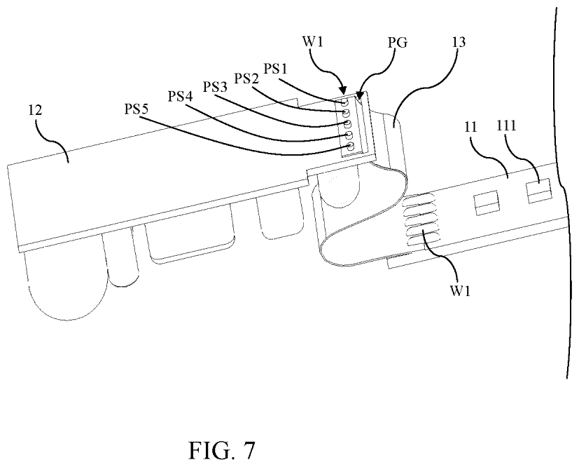

Please refer to FIG. 7, which is the schematic view of the connection structure of the flexible circuit board and the power board of the LED tube light having the flexible circuit board connection structure in accordance with the second embodiment of the present invention.

As shown in FIG. 7, the power board 12 has a groove PG and five electrodes ED1, ED2, ED3, ED4, ED5. The difference between this embodiment and the previous embodiment is that both ends of the groove PG are sealed.

The above special-designed groove structure can provide an effective position-limiting effect, such that the flexible circuit board 13 can be stably fixed with the power board 12. Besides, the above special-designed groove structure can effectively reduce the stress applied to the flexible circuit board 13 during the installation process so as to avoid that the welding points are damaged accordingly. In addition, the above special-designed groove structure can effectively prevent from defective welding conditions. In this way, the quality and reliability of the LED tube light 1 can be greatly enhanced.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the LED tube light includes a light source board, a power board and a flexible circuit board. The flexible circuit board has a first end and a second end. The first end is electrically connected to the light source board. The second end has a welding portion, and the second end is electrically connected to the power board via the welding portion. The flexible circuit board includes a plurality of connection portions and the connection portions are curved in shape, whereby the flexible circuit board is wavy. The above structure can significantly reduce the manufacturing cost of the LED tube light and increase the production efficiency of the LED tube light.

According to one embodiment of the present invention, the LED tube light has the flexible circuit board connection structure, so the power board of the LED tube light can be electrically connected to the light source board via the flexible circuit board having the connection circuit. Thus, the flexible circuit board connection structure will not be influenced by the limited space of the end caps, such that the power board and the light source board can normally operate.

According to one embodiment of the present invention, the LED tube light has the flexible circuit board connection structure, and the flexible circuit board is S-shaped and has a first connection portion and a second connection portion. The curvature of the first connection portion adjacent to the light source board is greater than that of the second connection portion adjacent to the power board. The above structure can optimize the stress distribution of the flexible circuit board without influencing the signal transmission function of the flexible circuit board.

Also, according to one embodiment of the present invention, the power board of the LED tube light has a groove and a plurality of electrodes. The second end of the flexible circuit board passes through the groove and is electrically connected to the electrodes via the welding portion. The above special-designed groove structure can provide an effective position-limiting effect, such that the flexible circuit board can be stably fixed with the power board. Besides, the above special-designed groove structure can effectively reduce the stress applied to the flexible circuit board during the installation process so as to avoid that the welding points are damaged accordingly. In addition, the above special-designed groove structure can effectively prevent defective welding conditions. In this way, the quality and reliability of the LED tube light can be greatly enhanced.

Further, according to one embodiment of the present invention, the flexible circuit board of the LED tube light has the welding portion and the welding portion includes a plurality of hollow welding pads corresponding to the electrodes respectively. Each electrode has an electrical connection post and the electrical connection post of each electrode passes through and welded on the hollow welding pad corresponding thereto. Via the structure design of the hollow welding pads and electrical connection posts, the welding process can be finished by automated welding technique in a short time. Further, the above structure design can also effectively decrease the stress applied to the flexible circuit board in order to avoid that the welding points are damaged. In this way, the quality and reliability of the LED tube light can be further improved.

Moreover, according to one embodiment of the present invention, the LED tube light has the flexible board connection structure, enabling the power board of the LED tube light to be electrically connected to the light source board via the flexible board having the connection circuit. Additionally, the flexible board will not break due to insufficient space, thereby effectively enhancing the service life of the LED tube light.

Furthermore, according to one embodiment of the present invention, the flexible board connection structure can be applied not only to tube lights but also to various other types of lighting devices, making it more versatile in applications and providing greater flexibility in use.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting diode tube light having a flexible circuit board connection structure, comprising:
a light source board;
a power board; and
a flexible circuit board having a first end and a second end, wherein the first end is electrically connected to the light source board, and the second end has a welding portion, and the second end is electrically connected to the power board via the welding portion;
wherein the flexible circuit board comprises a plurality of connection portions and the connection portions are curved in shape, whereby the flexible circuit board is wavy.

2. The light-emitting diode tube light having the flexible circuit board connection structure as claimed in claim 1, wherein the power board has a groove and a plurality of electrodes, and the second end passes through the groove and is electrically connected to the electrodes via the welding portion.

3. The light-emitting diode tube light having the flexible circuit board connection structure as claimed in claim 2, wherein the welding portion comprises a plurality of hollow welding pads corresponding to the electrodes respectively, wherein each of the electrodes has an electrical connection post, and the electrical connection post of each of the electrodes passes through and welded on the hollow welding pad corresponding thereto.

4. The light-emitting diode tube light having the flexible circuit board connection structure as claimed in claim 2, wherein one end of the groove has an opening and another end of the groove is sealed.

5. The light-emitting diode tube light having the flexible circuit board connection structure as claimed in claim 2, wherein both ends of the groove are sealed.

6. The light-emitting diode tube light having the flexible circuit board connection structure as claimed in claim 2, wherein the electrodes are adjacent to the groove.

7. The light-emitting diode tube light having the flexible circuit board connection structure as claimed in claim 1, wherein the flexible circuit board is S-shaped.

8. The light-emitting diode tube light having the flexible circuit board connection structure as claimed in claim 1, wherein the flexible circuit board has a connection circuit and the light source board is electrically connected to the power board via the connection circuit.

9. The light-emitting diode tube light having the flexible circuit board connection structure as claimed in claim 1, wherein the connection portions comprise a first connection portion adjacent to the light source board and a second connection adjacent to the power board, and a curvature of the first connection portion is greater than a curvature of the second connection portion.

10. The light-emitting diode tube light having the flexible circuit board connection structure as claimed in claim 1, further comprises two end caps and a light cover, wherein the two end caps are disposed at two ends of the light cover, and electrically connected to the power board and the light source board respectively, wherein the power board is disposed in one of the end caps and the light source board is disposed in the light cover.

11. A light-emitting diode tube light having a flexible circuit board connection structure, comprising:
a light source board;
a power board having a groove and a plurality of electrodes; and
a flexible circuit board having a first end and a second end, wherein the first end is electrically connected to the light source board, and the second end has a welding portion, and the second end passes through the groove and is electrically connected to the electrodes via the welding portion.

12. The light-emitting diode tube light having the flexible circuit board connection structure as claimed in claim 11, wherein the flexible circuit board comprises a plurality of connection portions and the connection portions are curved in shape, whereby the flexible circuit board is wavy.

13. The light-emitting diode tube light having the flexible circuit board connection structure as claimed in claim 12, wherein the flexible circuit board is S-shaped.

14. The light-emitting diode tube light having the flexible circuit board connection structure as claimed in claim 12, wherein the connection portions comprise a first connection portion adjacent to the light source board and a second connection adjacent to the power board, and a curvature of the first connection portion is greater than a curvature of the second connection portion.

15. The light-emitting diode tube light having the flexible circuit board connection structure as claimed in claim 11, wherein the welding portion comprises a plurality of hollow welding pads corresponding to the electrodes respectively, wherein each of the electrodes has an electrical connection post, and the electrical connection post of each of the electrodes passes through and welded on the hollow welding pad corresponding thereto.

16. The light-emitting diode tube light having the flexible circuit board connection structure as claimed in claim 11, wherein one end of the groove has an opening and another end of the groove is sealed.

17. The light-emitting diode tube light having the flexible circuit board connection structure as claimed in claim 11, wherein both ends of the groove are sealed.

18. The light-emitting diode tube light having the flexible circuit board connection structure as claimed in claim 11, wherein the electrodes are adjacent to the groove.

19. The light-emitting diode tube light having the flexible circuit board connection structure as claimed in claim 11, wherein the flexible circuit board has a connection circuit and the light source board is electrically connected to the power board via the connection circuit.

20. The light-emitting diode tube light having the flexible circuit board connection structure as claimed in claim 11, further comprises two end caps and a light cover, wherein the two end caps are disposed at two ends of the light cover, and electrically connected to the power board and the light source board respectively, wherein the power board is disposed in one of the end caps and the light source board is disposed in the light cover.
